(19) United States
(12) Patent Application Publication
(10) Pub. No.: US 2012/0075073 A1
(43) Pub. Date: Mar. 29, 2012

(54) RFID READER DEVICE

(75) Inventor: Michael FISLAGE, Leingarten (DE)

(73) Assignee: SICK AG, Waldkirch (DE)

(21) Appl. No.: 13/240,431

(22) Filed: Sep. 22, 2011

(30) Foreign Application Priority Data
Sep. 27, 2010 (EP) 10180349.2

(51) Int. Cl. G06K 7/01

(52) U.S. Cl. 340/10.1

(57) ABSTRACT

An RFID reader device (10) for reading an RFID transponder (36) is provided, the RFID reader device (10) comprising an antenna (16) for the transmission and/or reception of an RFID signal and at least one transceiver unit (18) connected to the antenna (16) to transmit and/or receive the RFID signal using antenna parameters. The antenna (16) comprises a data carrier (26) wherein the antenna parameters are stored, and the transceiver reception unit (18) is configured to access the data carrier (26) to read the antenna parameters.

The invention relates to an RFID reader device and a method for reading an RFID transponder according to the preamble of claim 1 and 11, respectively.

RFID reader systems are used for the identification of objects and goods, among other things in order to automate logistic movements. At a point of identification, especially at a change of the owner of the goods or a change of the means of transport, RFID trans-ponders attached to the goods are read, and where appropriate information is written back into the transponder. This leads to fast and transparent logistic movements. The collected information is used to control the routing and sorting of goods and products. Important applications of the automated identification are logistical distribution centers, such as used by parcel services, or the baggage check-in at airports.

RFID transponders can in principle be active, i.e. have their own power supply and generate electromagnetic radiation themselves. In practice, such transponders are less suitable for logistics, because the unit prices of these transponders cannot achieve the low level required for the mass market due to the power supply. For that reason, mostly passive transponders without their own power supply are used. In both cases, the transponder is excited by electromagnetic radiation of the reader device to transmit the stored information, wherein passive transponders obtain the required energy from the transmission energy of the reader system. According to the established ultra high frequency standard ISO 18000-6, passive transponders are read by the backscatter method.

RFID devices use internal or external antennas. In use it has to be ensured that the device meets national limit values. Since antennas from different manufacturers are connected, the characteristic parameters have to be set in each case according to the data sheet. In addition, the antenna cable loss of the connection cable of the external antenna has to be parameterized.

The verification of the correct parameterization according to the prior art relies exclusively on ensuring during startup that the parameters of the antenna are set correctly. The user himself has to take care, for example, that the maximum transmission power cannot be exceeded. This sometimes requires a deep technical understanding. Input errors or even deliberate manipulation in the worst case result in devices working outside the allowable limit values.

The conventional installation of external antennas thus requires skilled personnel and leaves room for manipulation. Therefore, incorrect parameterization with the corresponding liability consequences for exceeding the limit values may occur. A simple and inexpensive “plug and play” is not possible.

From DE 103 53 613 A1 a device for adapting and controlling an RFID antenna is known. The antenna characteristics are measured, and then an antenna matching is carried out. Due to the measuring of the antenna characteristics, this process is quite costly. Moreover, only a small fraction of the relevant antenna parameters is considered.

It is therefore an object of the invention to simplify the connection of different antennas to an RFID reader.

This object is satisfied by an RFID reader device according to claim 1 and a method for reading an RFID transponder according to claim 11. The invention starts from the basic idea to learn the necessary antenna parameters directly from the connected antenna. For this purpose, a data carrier is provided in the antenna on which the antenna parameters are stored. Here, antenna parameters are to be understood in a broad sense, because it also suffices if the data carrier provides enough information that the actual antenna parameters can be easily derived, for example by accessing a table or a database.

The invention has the advantage that the installation of an RFID reader is significantly simplified. No knowledge of the operating personnel about the antennas is required.

The antenna parameters are automatically chosen correctly, and the RFID reader can thus only be operated within the applicable standards.

Limit values set by standards concern the transmission, not the reception of electromagnetic signals. Nevertheless, the antenna parameters of the data carrier can also be used for the reception. Moreover, an RFID reader according to the backscatter method does not only transmit RFID signals, i.e. modulated signals used for the communication with RFID transponders, but also a carrier signal for their power supply. The antenna and antenna parameters are also used for this carrier signal.

An evaluation unit for reading and/or encoding RFID information is preferably provided that is connected to the transceiver unit. In this and subsequent paragraphs, the term preferably describes preferred, but optional features that are not necessarily required for the invention. Thus, the actually interesting RFID information can be extracted from or added to the RFID signals.

The transceiver unit is preferably configured to automatically read the antenna parameters upon connection of the antenna. Setting of the correct antenna parameters thus takes place immediately upon plugging in the antenna or the antenna cable, respectively. In another embodiment, the transceiver unit is preferably configured to automatically read the antenna parameters repeatedly during operation, for example in regular cycles. It is also conceivable to read the antenna parameters on request of the operator or a higher level system into which the RFID reader is integrated. In general, the antenna parameters are read from the data carrier and, where appropriate after conversions or adaptations, transferred into a memory of the RFID reader itself. Alternatively, it is also possible that the RFID reader directly accesses the data carrier as a memory.

Only an identification information of the antenna is preferably stored on the data carrier, and the transceiver unit determines the antenna parameters from the identification information. The antenna parameters themselves are for example stored in a table of the RFID reader or a higher level system. In this way, the memory demands of the antenna can be kept very small, and the flexibility for adapting and optimizing the antenna parameters required for the RFID reader is considerably increased.

The antenna is preferably an external antenna. That means that the antenna is not an internal part of the RFID reader and is not integrated into a housing thereof or fixedly attached thereto. An external antenna is meant to be replaced, so that the unambiguous assignment of the antenna parameters according to the invention is particularly advantageous.

The antenna is preferably connected to the RFID reader device with an antenna cable. The antenna cable is preferably one of a plurality of antenna cables usable for the connection of the antenna and having different length, but the same damping characteristic. There is therefore a set of standardized antenna cables designed for the RFID reader. The operator does not have to pay attention to use an antenna cable with a suitable damping characteristic and also does not have to parameterize the damping characteristic. Alternatively, a differing damping characteristic is allowed, and the damping characteristic is one of the parameters stored on the data carrier. In this case, the antenna cable should not be disconnectable from the antenna, or at least a coding for the connectors should be provided, to ensure that at any time only an antenna cable is connected to the antenna having the damping characteristic as stored.

The data carrier preferably is an RFID transponder. It can initially be read with generic antenna parameters, whereafter the appropriate antenna parameters are immediately available. During subsequent operation a filter is used, for example in the application software, to not regard this RFID transponder any longer. As an alternative to an RFID transponder any other known storage media are possible.

A number of parameters are candidates for antenna parameters, where in each application not necessarily all, but only one parameter or a selection of the parameters are stored on the data carrier, or not all antenna parameters stored on the data carrier are read. Some possible antenna parameters include: polarization, radiation resistance, impedance, efficiency, directivity, antenna gain, aperture or effective area, and bandwidth. Instead of the antenna parameters as such, processed parameters can be stored, i.e. parameters that are to be used in the RFID reader when it uses the corresponding antenna. Alternatively, the RFID reader itself determines these processed parameters from the antenna parameters.

The method in accordance with the invention can be further developed in a similar manner with additional features and shows similar advantages. Such advantageous features are described in an exemplary, but not exclusive manner in the subordinate claims following the independent claims.

The invention will be explained in the following also with respect to further advantages and features with reference to exemplary embodiments and the enclosed drawing. The Figures of the drawing show in:

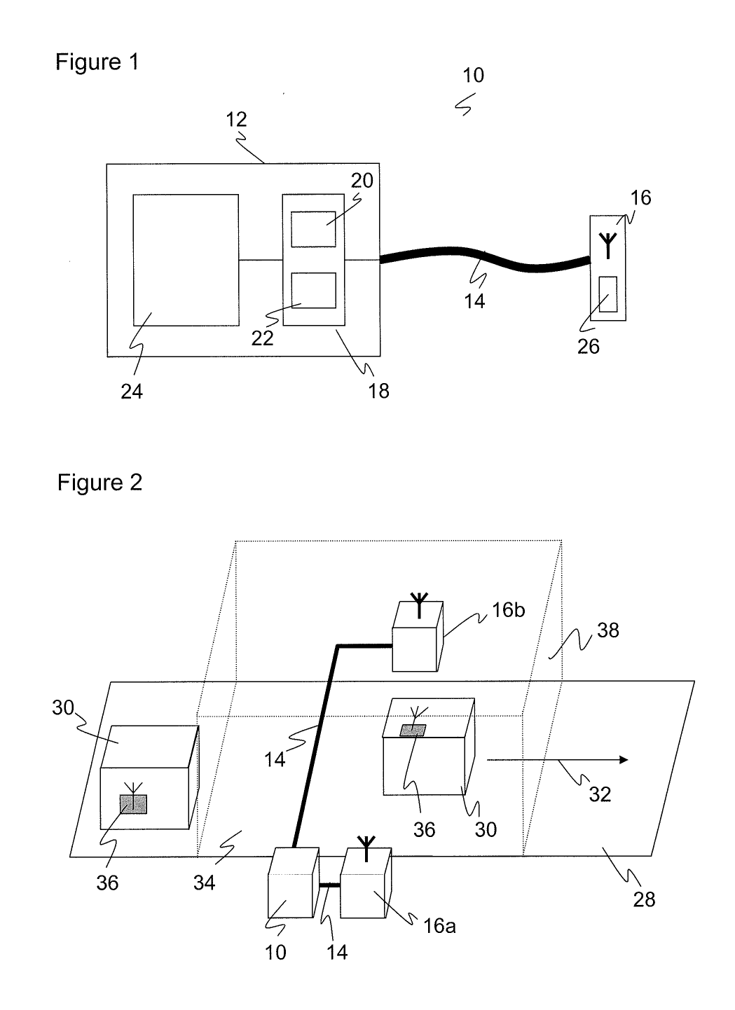

FIG. 1 a block diagram of an RFID reader according to the invention; and

FIG. 2 a three-dimensional view of the RFID reader according to FIG. 1 mounted at a conveyor belt.

FIG. 1 shows an embodiment of an RFID reader 10 in a block diagram. Usually, an RFID reader 10 is also capable to perform write operations on an RFID transponder, because common protocols require a bidirectional exchange of information in the first place to establish a communication link with the RFID transponder.

The evaluation and control electronics of the RFID reader 10 are arranged in a housing 12. Via an antenna cable 14, an antenna 16 is connected. A transceiver unit 18 comprises a transmitter 20 and a receiver 22 to receive RFID signals from the antenna 16 or to transmit RFID signals via the antenna 16.

A control and evaluation unit 24 is connected to the transceiver unit 18. The evaluation unit 24 receives an electronic signal corresponding to the received RFID signals from the receiver 22 and causes transmission of an RFID signal via the transmitter 20. The evaluation unit 24 has knowledge of the RFID protocols to be used to encode information into an RFID signal or to read information from an RFID signal. RFID communication as such is known in the art. Therefore, the required components of the evaluation unit 24 and the steps required for the RFID communication are not explained in any more detail.

A data carrier 26 arranged in or at the antenna 16 contains the important characteristics of the antenna 16. The RFID reader 10 checks at the initialization or subsequently which antenna 16 is used and automatically carries out the corresponding settings of the transceiver unit 18. To that end, signals of the data carrier 16 are evaluated that are transmitted via the antenna cable 14. The data carrier 26 is, for example, a memory chip in any known technology. The data carrier 26 can in itself be an RFID transponder. This is particularly useful if the RFID reader 10 has multiple antennas arranged in their mutual detection area. It is also conceivable to geometrically design the antenna 16 such that the data carrier 26 is within its detection area. During actual operation, signals of the data carrier 26 are masked, irrespective of whether they are RFID information or a different memory technology is used which utilizes the antenna cable 14 for transmission.

The RFID reader 10 or its transceiver unit 18 is thus directly parameterized by the data carrier 26 of the antenna, thereby ensuring that RFID reader 10 and antenna 16 work together in the desired manner and in particular comply with legal standards.

FIG. 2 shows a complementary three-dimensional view of a typical application of an RFID reader 10 in a stationary mounting at a conveyor belt 28. Objects 30 are conveyed on the conveyor belt 28 in a direction indicated by an arrow 32 through a reading area 34. RFID transponders 36 are arranged on the objects 30 which are read by the RFID reader 10 if they are in the reading area 34.

Above the reading area 34 a shielding 38 is provided that is only schematically shown. The shielding 38 protects both the RFID reader 10 from outside interference and the surroundings from the electromagnetic radiation of the RFID reader 10. The RFID reader 10 at the reading tunnel formed in this way comprises two antennas 16a-b, in contrast to the representation of FIG. 1. Additional RFID readers or additional antennas are possible, including internal antennas of the RFID reader 10 itself, in order to receive RFID signals at other positions and from other directions. Similarly, other sensors may be provided in order to obtain additional information about the objects 30, for example their entry into and exit from the reading area 34, or the volume or weight of the objects 30.

1. An RFID reader device (10) for reading an RFID transponder (36), the RFID reader device (10) comprising an antenna (16) for the transmission and/or reception of an RFID signal and at least one transceiver unit (18) connected to the antenna (16) to transmit and/or receive the RFID signal using antenna parameters,
characterized in that the antenna (16) comprises a data carrier (26) on which the antenna parameters are stored, and in that the transceiver reception unit (18) is configured to access the data carrier (26) to read the antenna parameters.

2. The RFID reader device (10) of claim 1,
wherein an evaluation unit (24) for reading and/or encoding RF ID information is provided that is connected to the transceiver unit (18).

3. The RFID reader device (10) of claim 1,
wherein the transceiver unit (18) is configured to automatically read the antenna parameters upon connection of the antenna (16).

4. The RFID reader device (10) of claim 1,
wherein the transceiver unit (18) is configured to automatically read the antenna parameters repeatedly during operation.

5. The RFID reader device (10) of claim 1,
wherein only an identification information of the antenna (16) is stored on the data carrier (26), and wherein the transceiver unit (18) determines the antenna parameters from the identification information.

6. The RFID reader device (10) of claim 1,
wherein the antenna (16) is an external antenna.

7. The RFID reader device (10) of claim 1,
wherein the antenna (16) is connected to the RFID reader device (10) with an antenna cable (14).

8. The RFID reader device (10) of claim 7,
wherein the antenna cable (14) is one of a plurality of antenna cables (14) usable for the connection of the antenna (16) and having different length, but the same damping characteristic.

9. The RFID reader device (10) of claim 1,
wherein the data carrier (26) is an RFID transponder.

10. The RFID reader device (10) of claim 1,
wherein the antenna parameters include at least one of the following parameters: polarization, radiation resistance, impedance, efficiency, directivity, antenna gain, aperture or effective area, and bandwidth.

11. A method for reading an RFID transponder (36) with an RFID reader device (10) whose antenna (16) transmits and/or receives an RFID signal using antenna parameters,
characterized in that the antenna parameters are stored on a data carrier (26) of the antenna (16), and in that the RFID reader device (10) accesses the data carrier (26) to read the antenna parameters.
